(19) United States
(12) Patent Application Publication
(10) Pub. No.: US 2020/0027368 A1
(43) Pub. Date: Jan. 23, 2020

(54) Symbol Manipulation Educational System and Method

(71) Applicant: Square Panda Inc., Sunnyvale, CA (US)

(72) Inventors: Andrew Butler, Sunnyvale, CA (US); Carey Lee, Sunnyvale, CA (US); Tom Boeckle, Las Vegas, NV (US); Debbie Heimowitz, Sunnyvale, CA (US); Vera Blau McCandliss, Sunnyvale, CA (US)

(21) Appl. No.: 16/016,585

(22) Filed: Jun. 23, 2018

Related U.S. Application Data
(63) Continuation-in-part of application No. 14/730,232, filed on Jun. 3, 2015.

(51) Int. Cl. G09B 17/00; G09B 7/08

(52) U.S. Cl. CPC G09B 17/006; G09B 7/08

(57) ABSTRACT

A system for teaching is disclosed, comprising a symbol identification dock and a plurality of symbol manipulatives, a computing device connected to the symbol identification dock, and a database, wherein the database comprises lexical data and an adaptive learning curriculum.

### CROSS-REFERENCE TO RELATED APPLICATIONS

The present application is a continuation-in-part of application Ser. No. 14/730,232, filed Jun. 3, 2015.

### BACKGROUND

### Field of the Invention

The present invention applies to the field of educational instruction and exploration systems for children, and more specifically relates to a system and method for interactively teaching first and early learners the skills necessary for the symbolic understanding of abstract systems including language, math, and logic using a combination of physical manipulatives, a dock or stage for the physical manipulatives, a software application on an interactive computer device, and an adaptive database system.

### Description of Related Art

Many modern educational applications exist for teaching children the basics of reading, including pre-reading skills such as alphabet recognition and phonemic awareness, numeracy, and logical reasoning. The most recent and innovative of these applications are configured for tablet and smartphone devices because their touch screens and other ease of use features suits them to young children and classroom use, whereas prior applications traditionally used with each generation of personal computers have primarily made use of the mouse and keyboard for interaction. These language education applications used by children on tablets and traditional computer devices make use of on-screen virtual representations of symbols in place of the real physical objects that have traditionally used in early language education; blocks with symbols displayed on them, or block shaped symbols.

This traditional use of physically manipulable symbols has evolved many effective teaching strategies well suited to eye-hand manipulation and object relationship centric stages in early childhood education. It is clear that children learn language best by combining their earliest learning of natural spoken language with learning the symbolic representations of that language. They learn words first as natural language representations of real world objects, and then are taught to physically manipulate symbolic objects to build visual symbolic representations for those symbols and their combinations in words. This develops their symbolic memory and mental modeling skills needed to learn the basics of literacy, phonemic awareness, numeracy, and logic.

There exists a need for a pre-school, pre-K and K education system and methods for learning literacy skills that combines the flexibility of interactive tablet devices and educational software applications with the physicality of symbol shaped manipulatives.

Early readers must master ordered sets of skills in order to progress through the stages of symbol and language understanding to attain reading fluency. At any stage a child can have difficulty integrating a subset of atomic or aggregate skills and experience a conceptual barrier disrupting steady learning progress. Some learners may require additional focused practice with those particular skills, with a previously completed skills or an untried set of skills in order to overcome the conceptual barrier and move to the next stage. Other learners may have mild to severe specific learning disabilities and require more focused and selective interventions in their development of these skill sets.

Educators and parents may not fully understand what these what these barrier skills are, if other supporting skills are weak or nonexistent, or if there are specific perceptual difficulties that contribute to the barrier. This complicates their ability to provide the right words, the focused demonstration, the needed switch to alternative tasks for associated skill sets, or potential structural or relational changes in the associated symbols that would reduce perceptual or cognitive confusions.

These considerations predicate the need for an educational system and methods that continuously assesses a learner's reading or pre-reading literacy skills and dynamically adapts their curriculum to optimize their progress in confronting and overcoming conceptual barriers. In particular an education system that addresses this need can be framed into three functional components: 1. Real-time assessment of a learner's state of progress—are they progressing or have they hit a conceptual barrier, 2. Adaptive selection and presentation of optimal teaching methods to overcome learning barriers—using real-time assessment information to select and respond with optimal teaching methods, 3. Associative integration of assessments and teaching responses from many learners to adaptively improve teaching responses for all learners—so that learners at similar stages with similar skill sets receive contextually optimal teaching responses.

### SUMMARY OF THE INVENTION

An object of the present invention is to provide an educational system and method that provides a combination of physical manipulatives and software to teach symbol manipulation skills.

Another object of the present invention is to provide an educational system and method that can assess a learner's current literacy skills and then adaptively introduce lessons and tasks to optimize their progress.

Another object of the present invention is to provide an educational system and method that can assist a learner in learning literacy principles by open-ended exploration.

The system of the present invention comprises a plurality of symbol manipulatives and a symbol identification device that can determine the identity and position of a symbol manipulative and communicate the identity and position to a computing device. The system further comprises a student computing device that is connected to the symbol identification device, comprising a processor, a memory, and an interface for connecting to the symbol identification device. The processor of the student computing device is configured to receive symbol identification data from the symbol identification device and present information to the user. The system further comprises a database that is configured to receive student response data, assess student response data, and make changes to at least one database component. The database comprises at least one of the following components: a personal database component, a lexical database component, a skills database component, a curriculum database component, and a supporting interactions database component.

The entire database may be located in the cloud, or it may be partially located on the student computing device and partially in the cloud. In an embodiment, the system further comprises a teacher computing device distinct from the student computing device, wherein the teacher computing device communicates with the student computing device through a remote interface. In that embodiment, part of the database may be located on the teacher computing device, part on the student computing device, and part in the cloud.

In an embodiment, the processor is configured to present a user with at least one task, wherein the task can be completed by connecting symbol manipulatives to the symbol identification dock. Once the user completes the at least one task, the processor determines the percentage of correctly completed tasks and the category of errors made by the user, and records this in the personal database component. The user is then presented with at least one targeted task intended to correct the errors.

The tasks may be organized into categories, preferably comprising the following: tasks related to phonological awareness, tasks related to letter-sound correspondence, tasks related to consonant blends and digraphs, tasks related to complex vowels, and tasks related to multisyllabic words.

The tasks may be organized into key skill domains, wherein the key skill domains comprise the following: print concepts, phonological awareness, phonics, spelling, writing, vocabulary, fluency, and comprehension.

The symbol manipulatives may comprise letter shapes, number shapes, logographic shapes, or symbol shapes.

In an embodiment, the processor may also be configured to identify any symbol manipulatives connected to the symbol identification dock, generate a pronunciation for the symbol manipulatives, and use the at least one effector to present the pronunciation to the user.

In an embodiment, the student computing device is a tablet.

In an embodiment, the student computing device is wirelessly connected to the symbol identification dock.

The method of the present invention comprises presenting a student with a plurality of symbol manipulatives and a symbol identification dock, wherein symbol manipulatives may be placed on the symbol identification dock, wherein the symbol identification dock identifies the symbol manipulatives placed on it, wherein the symbol identification dock is connected to a student computing device. The student is then presented with a first task, wherein the task can be completed by placing symbol manipulatives on the symbol identification dock. The task is derived from a curriculum database component, which comprises curricula, lessons, tasks, games, and open exploration activities, or any combination of the above. The system then detects any symbol manipulatives connected to the symbol identification dock in response to the first task, detects if the task was performed correctly, and if the task was performed incorrectly, determines the type of error made by the student. The student's response to the first task is then used to assess the student's skill level on at least one skill, such as physical manipulation skill, memory skill, perceptual skill, mental modeling skill, or any combination of these. The assessment is then recorded in the personal database component, which comprises at least one of the following: a lesson plan, a response record, a supporting interactions record, and a specific learning interaction record for the individual student.

In an embodiment, if a student places any symbol manipulative incorrectly during the performance of a task, the student is provided with at least one of the following: an encouragement, a suggestion, a hint, an instructive model, an intervention.

In an embodiment, the time period between any two symbol manipulatives being placed on the symbol identification dock is measured. If there is an unusual delay, the student is provided with at least one of the following: an encouragement, a suggestion, a hint, an instructive model, an intervention.

In an embodiment, if the student's response to the first task was incorrect, presenting the student with a second task, wherein the second task comprises a targeted intervention intended to focus on the type of error made by the student.

In an embodiment, if the student's response to the first task was correct, presenting the student with a second task, wherein the second task comprises the same type of task as the first task and requires a faster response time than the first task.

In an embodiment, if the student's response to the first task was correct, presenting the student with a second task, wherein the second task is more advanced than the first task.

In an embodiment, a method of the present invention comprises presenting a student with a plurality of symbol manipulatives and a symbol identification dock, wherein symbol manipulatives may be placed on the symbol identification dock, wherein the symbol identification dock identifies the symbol manipulatives placed on it, wherein the symbol identification dock is connected to a student computing device. Any symbol manipulatives connected to the symbol identification dock are then identified. The student computing device then generates a pronunciation for the symbol manipulatives and presents the pronunciation to the student using the at least one effector.

### LIST OF FIGURES

FIG. 1 shows an embodiment of the system of the present invention.

FIG. 2 shows an embodiment of the symbol identification dock and symbol manipulatives of the present invention.

FIG. 3A shows a flowchart for the process of teaching letter-sound correspondence by means of the present invention.

FIG. 3B shows a flowchart for the process of teaching letter-sound correspondence by means of the present invention.

FIG. 4 shows a sample entry for the lexical database of the present invention.

### DEFINITIONS

For purposes of the present disclosure, a “child”, “student”, “user”, or “learner” is a person who is using the system of the present invention. A “computing device” is a laptop computer, desktop computer, tablet, smartphone, wearable computer, or any other computing device capable of running the educational software of the present invention and connecting with the symbol identification dock.

### DETAILED DESCRIPTION OF THE PREFERRED EMBODIMENT

The present invention offers a system and method for pre-school, pre-kindergarten, and kindergarten children to learn the symbolic expression of a language as they are learning its spoken form. This system is configured for their independent learning through a guided curriculum with little oversight other than initial introduction and ongoing supportive attention. The methods of this system serve to select a current best or optimal curriculum for the child's assessed language skills, to measure a child's progress and recognize learning barriers as they occur and adaptively change the teaching instructions to overcome those barriers. These methods continuously evaluate the effectiveness of teaching changes made for many children in order to optimize and customize curriculum, lessons, tasks, and intervention responses for every child.

The present invention is directed to an instructional system for teaching abstract thinking and symbol manipulation via physical manipulatives combined with a computing device. While the preferred embodiment of the invention uses letter-shaped manipulatives to teach literacy skills, it will be understood that other applications of the present invention may incorporate other symbol manipulatives, such as numbers, logographic characters, or any other symbols.

### Overview of System

The present invention is directed to an instructional system for teaching abstract thinking and symbol manipulation to children as they interact with physical manipulatives and a computing device. This physical manipulation of abstract symbols is a key element of the present invention, because in early literacy learning, the patterns of physical manipulation are transformed into similar patterns of mental manipulation. While the preferred embodiment of the invention uses letter-shaped manipulatives to teach literacy skills, it will be understood that other applications of the present invention may incorporate other symbol manipulatives, such as numbers, logographic characters, or any other symbols.

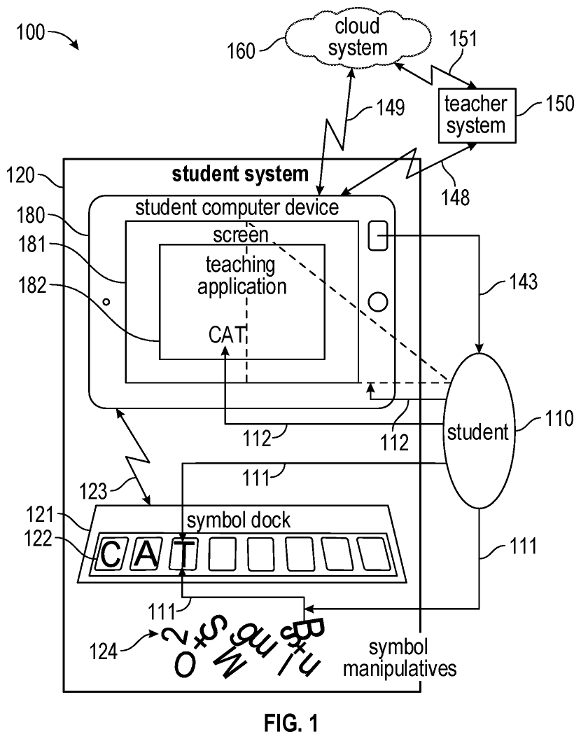

In the present invention illustrated in FIG. 1, the student system 120 comprises a student computing device 180 on which a teaching application 182 executes to present instructions and tasks related to a customizable curriculum to a student 110 by using visual and audio instructions 143. The student 110 responds with touch and voice interactions 112 and by selecting and connecting symbol manipulatives 124 to a symbol identification dock 121 by placing them in recesses on the top surface of the dock 122. The symbol identification dock uniquely determines the identity (name) and position of each connected symbol manipulative and communicates the identity and location of symbol manipulatives as they are connected to the teaching application 182 over a wireless link 123.

In the preferred embodiment the student computing device 180 is a tablet computer such as an iPad or Android Tablet that connects with the symbol identification dock over a Bluetooth wireless link 123, though any other wireless or wired connection may be used. The student computing device 180 preferably comprises effectors for output—in the preferred embodiment, the effectors are a display screen and speakers—and sensors for input. In the preferred embodiment, the sensors are a microphone and a camera.

As an interaction progresses, the teaching application 182 can pass real-time indications of the learning interaction to a teacher system 150, and/or a cloud system 160, and receive responses of real-time teaching changes from these systems. The teaching application communicates with the teacher and cloud systems over wireless connections 148 and 149. The real-time interaction information sent includes: correct and incorrect letter selections, speed of response, voice and touch responses, and other indications of the student's engagement in the learning process.

The student system, the teacher system, and the cloud system comprise separate applications and a joint teaching database. The student teaching application serves to present instructional material and interact with a student, to assess a student's responses, and manage the curriculum, lessons, tasks and supportive interactions by accessing a teaching database.

The applications and teaching databases in teacher and cloud systems receive student interaction data, assess student responses to instruction, and in turn provide real-time changes to curriculum, lessons, tasks, and supportive interactions back to the student teaching application.

In an embodiment (not shown), the teaching database in the student teaching application is a smaller subset of the teaching database in the teacher system, which in turn is a smaller subset of the teaching database in the cloud system. When the student teaching application is not connected to teacher and cloud systems it can make use of a teaching database subset to teach students in a standalone mode. While connected it may rely on either the database in the teacher or cloud system.

These applications and databases together form a complete teaching system that is adaptive in providing real-time instructions to meet each student's need as they progress through their learning engagements. The applications in each of these systems additionally serve to optimize the joint teaching database over time as the effectiveness of teaching instructions presented to many children are continuously evaluated and integrated.

### Symbol Dock and Manipulatives

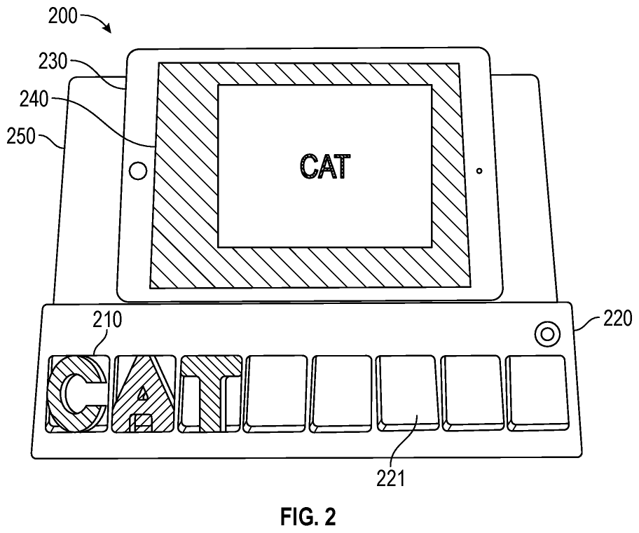

In the preferred embodiment of the system illustrated in FIG. 2, the symbol identification dock 220 comprises eight recessed letter spaces 221 that serve both as containers to position and align symbol or letter manipulatives 210, and as letter readers providing an information connection between the letters and the dock.

In the preferred embodiment the symbol or letter manipulatives 210 are letter shaped to make the learning experience tactile as well as visual. In other embodiments symbol manipulatives may be shaped like rectangular tiles with three-dimensional letter protrusions on them, as alphabet blocks with letters on the faces, or in other forms that facilitate manipulation and symbol identification.

The symbol identification dock 220 comprises a board accommodating letter arrangements that can sense identities and relative positions of letters that are placed on, connected to, touching or in close proximity to it. The symbol identification dock additionally comprises a processor and memory to enable the sensing and identification of letters and communication of the identified properties of each letter to the student's computing device.

In the preferred embodiment, the symbol or letter connections to the dock are comprised of ‘letter reader’ matrices of capacitive sensing pads in the bottom of each letter recess 221. These sensing pads read the encoded pattern of conductive pads on the bottom of inserted letters to determine the unique ID of each letter, e.g. “A”.

While the preferred embodiment comprises capacitive identification and sensing means to identify letters, a wide range of other identification and sensing means can be used, including: direct electrical connection, RFID tags and sensors, optical sensing, and magnetic sensing.

In an embodiment, the symbol manipulatives may also be colored different colors, and/or may have different textures to make the learning experience even more sensory. For example, vowels may be colored differently from consonants. In another embodiment, the symbol manipulatives may also comprise Braille patterns for the letter in question. The symbol manipulatives are preferably made of a nontoxic and durable material that is safe for young children to use.

In another embodiment, the symbol identification dock 220 has a backlit surface that illuminates each letter space so that a child knows where place the letter. This can be an underline, a dot, the entire perimeter of the space, or the entire space. The symbol manipulatives may also be translucent or partially translucent so that they can glow when selected. The backlighting may also be used to illuminate particular letters; for example, letters that comprise compound consonants such as TH may be backlit, or silent letters may be backlit, depending on the needs of the user.

In yet another embodiment, the symbol identification dock additionally comprises a stand to support and orient the student computing device and a storage space to store symbol manipulatives that are not in use.

### Teaching Modes and Applications

The teaching application of the present invention comprises a range of seamlessly linked applications and separate applications that serve tutor students in language literacy. These applications provide a range of interaction modes including curriculum-oriented applications with formal lessons and tasks, competitive game oriented applications, and open ended exploratory play oriented applications.

### Curriculum Applications

The primary teaching applications of the present invention comprise integrated sub-applications that instruct students by presenting learning tasks in a range of forms or modes. These modes may include formal tasks for trial and error learning, speed-test games as assessments of progress, and interactive communication with virtual playmates providing encouragement, support and coaching. The focus of these sub-applications, ranges from rapid learning, to slower paced consolidation and reinforcement of just learned skills. A child's pace lesson tasks, assessment as games, and virtual playmate modes is steady and learning focused.

### Game Applications

The present invention may be used for learning games that are independent of any curriculum or assessment. Any games that require a child to place symbol manipulatives on the symbol identification dock as the interaction may be part of the present invention. As a non-limiting list of possible embodiments, such games may be interactive stories that require a child to fill in words in the story or create new stories based on words the child inputs; letter-sound matching games that require a child to find a letter that matches the sound or vice versa; and so on.

### Open-Ended Play

The English language (as well as many other languages) has complex rules of pronunciation and spelling that are not easy to explain or articulate to a small child. As such, it is a more efficient process to enable the child to simply explore different letter combinations and their pronunciations, so that the child can learn the rules of pronunciation implicitly.

In an embodiment of the present invention, a child is encouraged to connect symbol manipulatives to the symbol identification dock in any order or any combination. The symbol identification dock then identifies the manipulatives and their order and sends that information to the student computing device. The student computing device then uses the lexical database to look up the pronunciation for the particular combination of manipulatives created by the child. In an alternate embodiment, the student computing device comprises a set of rules for generating pronunciations for letter combinations based on the phonics rules for the English language, and those rules are applied to the letter combination to generate a pronunciation for the particular combination of manipulatives created by the child.

In an embodiment, if a child is placing manipulatives in an open-ended undirected way, and ends up creating a word (for example, “CAT”), either intentionally or accidentally, the computing device recognizes the word and displays an image or animation of a cat on the screen, in addition to generating a pronunciation for the word.

### Assessing Learning Performance

In an embodiment, the present invention may comprise software that comprises lessons intended to teach literacy skills to students. In the preferred embodiment, the lessons are organized into an integrated learning path comprising 7 key skill domains, including: Print Concepts, Phonological Awareness, Phonics, Spelling/Writing, Vocabulary, Fluency, and Comprehension.

The curriculum is presented to a student in teaching phases, defined as steps in learning literacy skills. Each teaching phase covers a particular lesson or concept that is presented sequentially so that subsequent stages are reached only by mastering prior stages. In the preferred embodiment, the teaching phases are:
a. Phase 1: Phonological awareness (focus on initial phonological/phonemic awareness building activities, songs/rhymes, stories, spoken phoneme blending and segmenting, introduction to A-Z letter identification.
b. Phase 2: Letters and Sounds (introduce 26 letters and sounds; phoneme segmenting/blending with letters; introduce high-frequency and partially decodable words; start blending/segmenting VC/CV/CVC with letters; writing/tracing letters).
c. Phase 3: Consonant Blends, Digraphs (focus on consonant blends and digraphs, decode/spell CCVC/CVCC words with introduced blends, read sentences)
d. Phase 4: Complex Vowels (focus on vowel digraphs, long vowels, silent e, R-control, diphthongs, decode/spell CVVC, CCVVC, CVVCC words, derive words' meanings from context, read paragraphs)
e. Phase 5: Complex Words (focus on reading and spelling multisyllabic words, words with inflectional endings, affixes, complex ending patterns, writing sentences, reading longer text passages).

Each phase comprises lessons and tasks that incorporate each one of the 7 key skill domains.

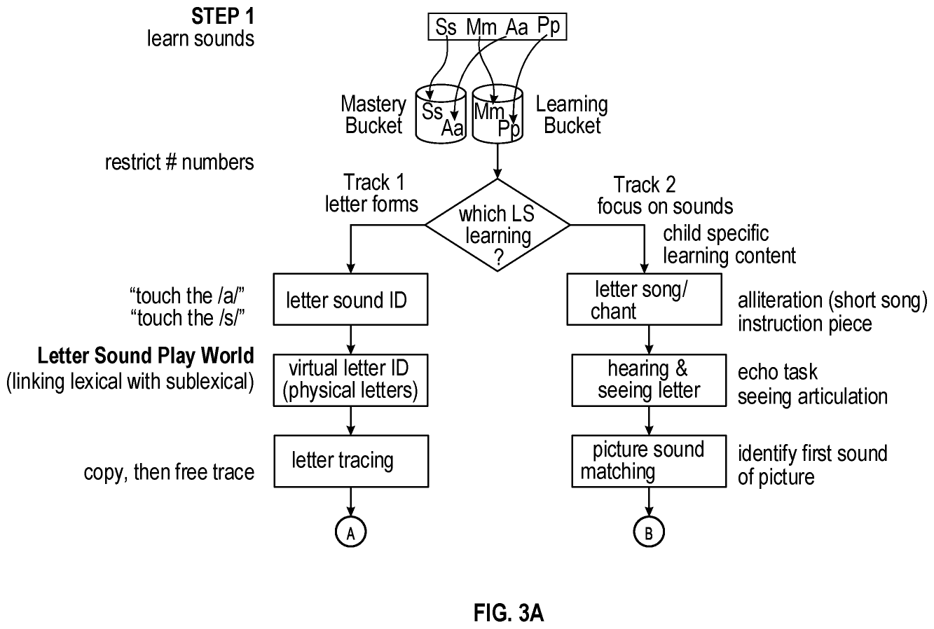

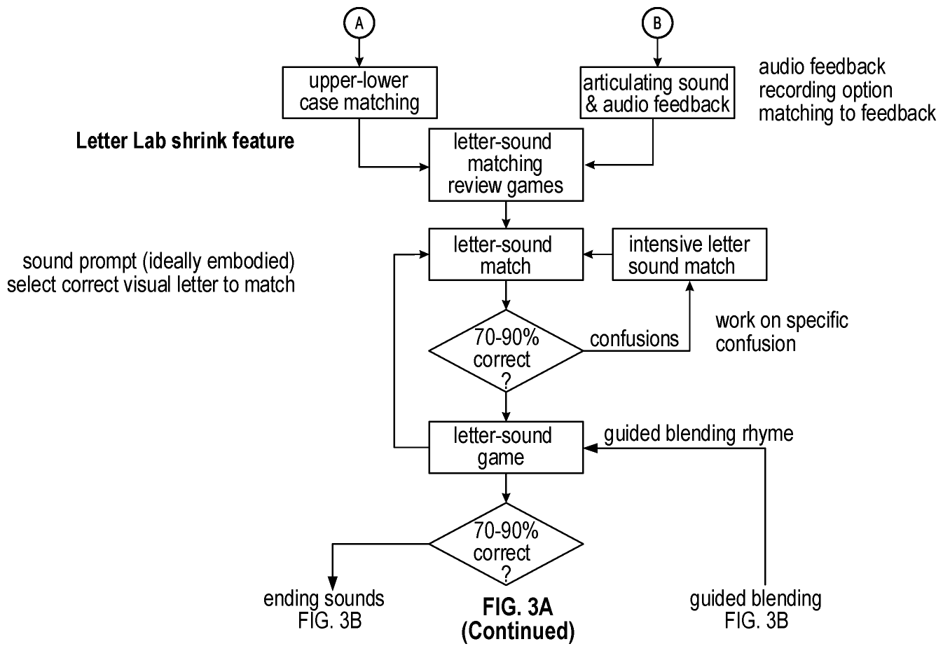

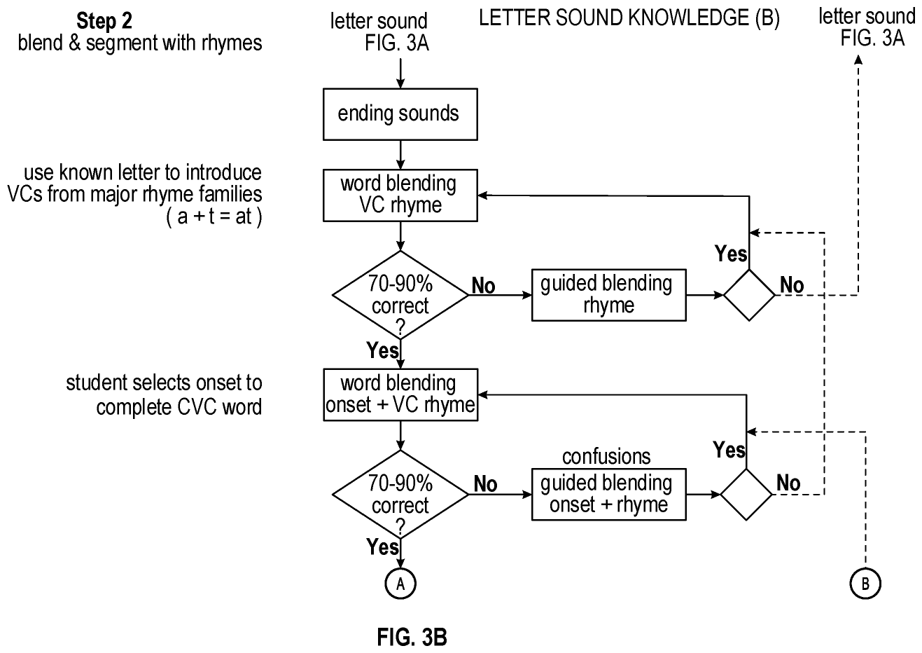

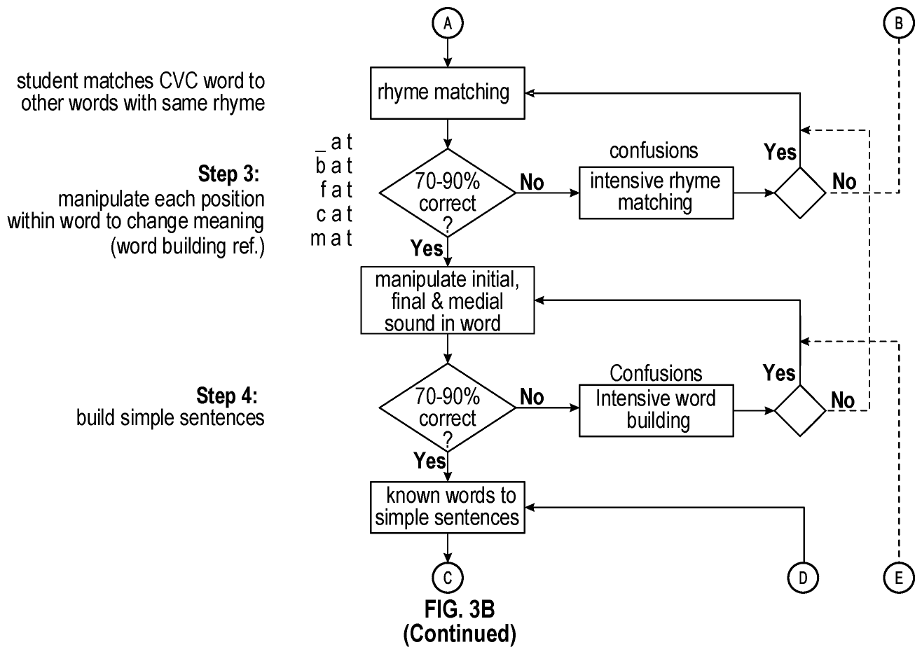

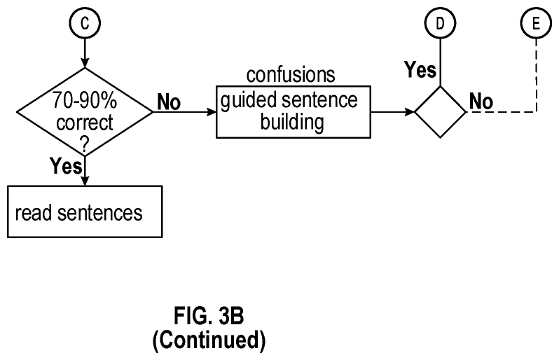

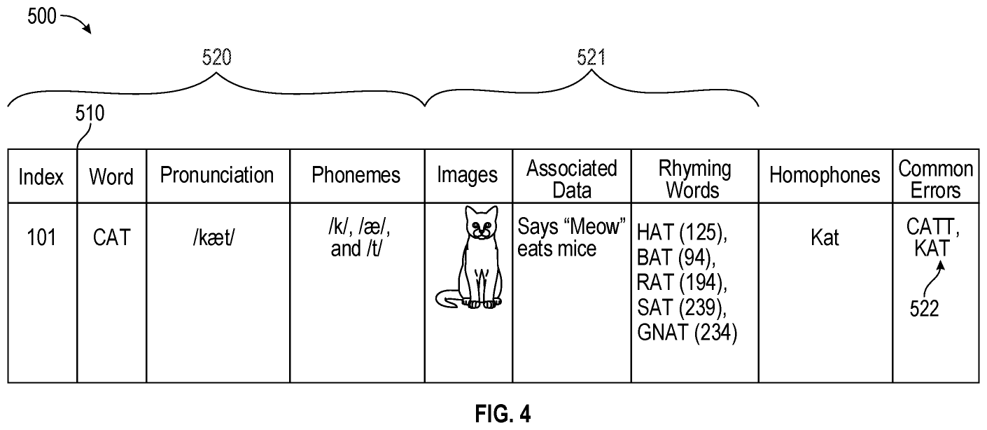

An instruction flow chart for the “Letters and Sounds” part of the curriculum is illustrated in FIGS. 3 and 4. The instructions start with a child learning letter sounds. At the beginning of the letter-sound interaction the child's letter-sound correspondence skills are either assessed or derived from past interactions and those that the child knows are put into the “mastery bucket” and those that they have difficulty with or don't know are put into the “learning bucket” and are saved as well in the child's personal database portion of the teaching database.

The correspondences in the “learning bucket” are then presented to the child in a game-like context along one of two separate tracks. The track that a child takes depends on whether the child has greater difficulty with the visual (letter shapes) or aural (letter sounds) aspects of the learning experience.

Along the visual track, the child is encouraged to use physical manipulatives to match letters on the screen, to match uppercase and lowercase letters, and to trace letters on the touchscreen. Along the aural track, the child is presented with a letter song/chant, is encouraged to echo a letter sound, to match pictures and sounds, and to articulate sounds with audio feedback. After all the letter-sound correspondences in the “learning bucket” have been covered, the child is given a “review game” to repeat the assessment of their current level of letter-sound mastery.

When a child mastery reaches 70-90% of the letter-sound correspondences they move on to a letter-sound speed game, where they are given tasks by animated characters in a fun game-like atmosphere to improve student engagement. As the student performs each task, their performance on the task is assessed in real-time. The variables used to assess student performance in this interactive play may comprise, among others, the speed of letter placement, pauses during the task, and errors made by the student. The assessment of a child's performance in the letter-sound speed game is then used to evaluate the student on at least one dimension of literacy skills.

As an example, if a child consistently makes an error with the “CH” in the word CHURCH, the system may determine that this is an error characteristic for the student and include that in the assessment. The student may then be given lessons that focus on the CH phoneme. In an embodiment, lessons that focus on a particular issue may be ‘scaffolded’ to provide the student with the optimal environment to improve learning.

An example of scaffolding would be: since phonemes at the start of a word are easier to hear than phonemes at the end of a word, the child may first be presented with words that start with CH, and only after that step is mastered, the child may be given words that end with CH. In the preferred embodiment, since language data is tracked, if the child is Spanish-speaking bilingual, the child may also be given CH words in Spanish.

In the preferred embodiment, the “learner profile”—i.e. the assessment of the learner's performance—is continually updated as the learner performs more and more tasks. This leads to a highly individualized adaptive curriculum that is tailored to the particular learner and their individual needs.

### Database

### Lexical Database Component

The present invention comprises a database that comprises several components. One of these components is a lexical database component, which is preferably stored in the cloud. A smaller subset of the lexical database may be located on a teacher's computing device for easier access, and an even smaller subset of the lexical database, comprising just the most common words, pronunciations, related words, and tags, may be located on the student computing device or in the symbol identification dock itself. In an embodiment, the entire lexical database is located in the cloud and the student and teacher computing devices simply draw all their data from the cloud; in another embodiment, the entire lexical database is located on the student computing device or symbol identification dock for a standalone system.

The lexical database preferably comprises any lexical data that may be needed for teaching literacy skills. In the preferred embodiment, the lexical database comprises a list of words that may be relevant to a student learning to read. Each word is associated with an index number, a pronunciation, the phonemes comprising the word, common errors made in spelling that word, an image and/or video of the object or concept described by the word (and any associated data such as the sound made by an animal or what the animal eats), and pointers to words (identified by index number) that rhyme with that word, compound words that comprise that word, homographs, homonyms, and so on. For example, the entry for CAT may look like the one pictured in FIG. 5.

In an embodiment, the lexical database may also comprise multiple languages. For example, the entry for CAT may also comprise GATO (in Spanish) or KOT (in Russian).

In an embodiment, the lexical database may comprise separate classes of errors, based on the child's cognitive skills and morphologies of specific learning disorders. For example, some errors may be very typical and diagnostic of dyslexia. For example, if a child spells CAT as TAC, the system may classify the error as “potential for dyslexia”).

In the preferred embodiment, each word and each phoneme is also associated with any lessons that teach literacy skills for which that particular word or that particular phoneme is relevant. For example, the word CHURCH may be associated with lessons that teach the CH phoneme.

It will be understood that the lexical database may comprise any combination of the above data and that the present invention is not limited to the particular types of data provided in the example given above.

### Personal Database

The database preferably also comprises a personal database component. The personal database component preferably comprises information about the student, including the learner profile mentioned above. The personal database component may also comprise information such as the student's age, any specific learning indications or challenges, the student's native language, and any “personal words” specific to the student, such as names of family members or pets, the student's name, or any special words unique to the user, along with the same information about each “personal word” as is present in the lexical database for any other word.

In an embodiment, the personal database also includes the response record for the student, the skills record for the student (evaluations based on each one of the literacy skills in the 7 skill domains), and any supporting interactions record for the student (i.e. how often the student received hints or other assistance as described below).

### Skills Database

In an embodiment, the database also comprises a skills database component, recording any literacy or pre-literacy skills on which the student may need to be assessed. In the preferred embodiment, the skills database includes physical manipulation skills, memory skills, perceptual skills, mental modeling skills, and any combination of these skills into an aggregate skill.

### Curriculum Database

In an embodiment, the database also comprises a curriculum database component. The curriculum database preferably includes at least one curriculum, where each curriculum is organized into lessons; each lesson is organized into tasks. The curriculum database may also include games and open exploration activities relevant to the curriculum. The preferred composition of the curriculum in the preferred embodiment of the present invention is described above.

### Supporting Interactions Database

In an embodiment, the database also comprises a supporting interactions database component. The supporting interactions database component preferably comprises encouraging messages like “You can do it!”, suggestions and hints for how to complete tasks (“The letter you need is round!”), instructive models, and interventions. In the preferred embodiment, the system detects when a student makes an error during the completion of a task or pauses for an unusually long time during the completion of a task, and locates an appropriate intervention in the supporting interactions database. The appropriate intervention may be an encouragement, a simple hint, or a more detailed explanation.

It is to be understood that this invention is not limited to particular aspects described, and, as such, may vary. It is also to be understood that the terminology used herein is for the purpose of describing particular aspects only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual aspects described and illustrated herein has discrete components and features which may be readily separated from or combined with the features of any of the other several aspects without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and aspects of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary aspects shown and described herein. Rather, the scope and spirit of present invention is embodied by the appended claims.

1. A system for teaching, comprising:
a plurality of symbol manipulatives;
a symbol identification device that can determine the identity and position of any symbol manipulative and communicate the identity and position to a computing device;
a student computing device connected to the symbol identification device, wherein the student computing device comprises a processor, a memory, and an interface for connecting to the symbol identification device;
wherein the processor is configured by means of software and data to perform the following actions:
receive symbol identification data from the symbol identification device;
present information to the user;
a database, configured by means of software and data to perform the following actions:
receive student response data from at least one processor connected to one symbol identification device;
assess the student response data from the at least one processor connected to one symbol identification device to determine a measure of student understanding;
make changes to at least one database component;
respond to at least one processor connected to one symbol identification device with teaching data;
wherein the database comprises at least one of the following components:
a personal database component, wherein the personal database component comprises at least one of the following:
a lesson plan for an individual student;
a response record of the individual student;
a skills record of the individual student;
a supporting interactions record of the individual student;
a specific learning indications record of the individual student;
at least one personal word, wherein a personal word is selected from the following categories:
names of family members or pets, name of the user, special words unique to the user;
a pronunciation of the at least one personal word;
phonemes comprising the at least one personal word;
images associated with the at least one personal word;
data associated with the at least one personal word;
at least one rhyming word associated with the at least one personal word;
at least one homophone associated with the at least one personal word;
at least one common error made by students in spelling the at least one personal word;
a lexical database component, wherein the lexical database component comprises at least one of the following:
at least one word;
a pronunciation of the at least one word;
phonemes comprising the at least one word;
images associated with the at least one word;
data associated with the at least one word;
at least one rhyming word associated with the at least one word;
at least one homophone associated with the at least one word;
at least one common error made by students in spelling the word;
at least one translation of the at least one word into a foreign language;
at least one syllable;
a pronunciation of the at least one syllable;
phonemes comprising the at least one syllable;
a skills database component, wherein the skills database component comprises at least one of the following:
at least one physical manipulation skill;
at least one memory skill;
at least one perceptual skill;
at least one mental modeling skill;
at least one combination of skills into an aggregate skill;
a curriculum database component, wherein the curriculum database component comprises at least one of the following:
at least one curriculum;
at least one lesson;
at least one task;
at least one game;
at least one open exploration activity;
a supporting interactions database component, wherein the supporting interactions database component comprises at least one of the following:
at least one encouragement;
at least one suggestion;
at least one hint;
at least one instructive model;
at least one intervention.

2. The system of claim 1, wherein the entire database is located in the cloud.

3. The system of claim 1, wherein part of the database is located on the student computing device and part of the database is located in the cloud.

4. The system of claim 1, further comprising:
a teacher computing device distinct from the student computing device, wherein the teacher computing device communicates with the student computing device through a remote interface.

5. The system of claim 4, wherein part of the database is located on the student computing device, part of the database is located on the teacher computing device, and part of the database is located in the cloud.

6. The system of claim 1, wherein the processor is further configured to perform the following actions:
present a user with at least one task, wherein the task can be completed by connecting symbol manipulatives to the symbol identification dock;
once the user completes the at least one task, determine the percentage of correctly completed tasks and the category of errors made by the user;
record the percentage of correctly completed tasks and the category of errors in the personal database component;
present the user with at least one targeted task intended to correct the error in the category of errors made by the user.

7. The system of claim 6, wherein tasks are organized into categories, wherein the categories comprise the following:
tasks related to phonological awareness;
tasks related to letter-sound correspondence;
tasks related to consonant blends and digraphs;
tasks related to complex vowels;
tasks related to multisyllabic words.

8. The system of claim 6, wherein tasks are organized into key skill domains, where the key skill domains comprise the following:
print concepts;
phonological awareness;
phonics;
spelling and writing;
vocabulary;
fluency;
comprehension.

9. The system of claim 1, wherein the symbol manipulatives comprise letter shapes.

10. The system of claim 1, wherein the symbol manipulatives comprise number shapes.

11. The system of claim 1, wherein the symbol manipulatives comprise logographic shapes.

12. The system of claim 1, wherein the symbol manipulatives comprise symbol shapes.

13. The system of claim 1, wherein the processor is further configured to perform the following actions:
identify any symbol manipulatives connected to the symbol identification dock;
generate a pronunciation for the symbol manipulatives;
present the pronunciation to the user.

14. The system of claim 1, wherein the student computing device is a tablet.

15. The system of claim 1, wherein the student computing device and the symbol identification dock are connected to each other wirelessly.

16. A method of teaching symbol manipulation, comprising:
presenting a student with a plurality of symbol manipulatives and a symbol identification dock, wherein symbol manipulatives may be placed on the symbol identification dock, wherein the symbol identification dock identifies the symbol manipulatives placed on it, wherein the symbol identification dock is connected to a student computing device;
presenting the student with a first task, wherein the task can be completed by placing symbol manipulatives on the symbol identification dock, wherein the first task is derived from a curriculum database component, wherein the curriculum database component comprises at least one of the following:
at least one curriculum, the at least one curriculum comprising at least one lesson;
at least one lesson, the at least one lesson comprising at least one task;
at least one task;
at least one game;
at least one open exploration activity;
detecting any symbol manipulatives connected to the symbol identification dock in response to the first task;
determining if the first task was performed correctly;
if the first task was performed incorrectly, determining the type of error made by the student;
using the student's response to the first task to assess the student's skill level on at least one of the following skills:
at least one physical manipulation skill;
at least one memory skill;
at least one perceptual skill;
at least one mental modeling skill;
at least one combination of skills into an aggregate skill;
recording the student's skill level in a personal database component, wherein the personal database component comprises at least one of the following:
a lesson plan for an individual student;
a response record of the individual student;
a skills record of the individual student;
a supporting interactions record of the individual student;
a specific learning indications record of the individual student.

17. The method of claim 16, further comprising:
after each letter manipulative is connected to the symbol identification dock in response to the first task, determining whether or not it is correct;
if it is incorrect, providing the student with at least one of the following:
at least one encouragement;
at least one suggestion;
at least one hint;
at least one instructive model;
at least one intervention.

18. The method of claim 16, further comprising:
monitoring a time period between any two letter manipulatives being connected to the symbol identification dock in response to the first task;
if any time period is longer than a predetermined time period, providing the student with at least one of the following:
at least one encouragement;
at least one suggestion;
at least one hint;
at least one instructive model;
at least one intervention.

19. The method of claim 16, further comprising:
if the student's response to the first task was incorrect, presenting the student with a second task, wherein the second task comprises a targeted intervention intended to focus on the type of error made by the student.

20. The method of claim 16, further comprising:
if the student's response to the first task was correct, presenting the student with a second task, wherein the second task comprises the same type of task as the first task and requires a faster response time than the first task.

21. The method of claim 16, further comprising:
if the student's response to the first task was correct, presenting the student with a second task, wherein the second task is more advanced than the first task.

22. A method of teaching phonics, comprising:
presenting a student with a plurality of symbol manipulatives and a symbol identification dock, wherein symbol manipulatives may be placed on the symbol identification dock, wherein the symbol identification dock identifies the symbol manipulatives placed on it, wherein the symbol identification dock is connected to a student computing device, wherein the student computing device comprises at least one effector;
detecting and identifying any symbol manipulatives connected to the symbol identification dock;
generating a pronunciation for the symbol manipulatives;
use at least one effector to present the pronunciation to the student.
